(19) United States
(12) Patent Application Publication
(10) Pub. No.: US 2008/0044795 A1
(43) Pub. Date: Feb. 21, 2008

(54) Implant

(76) Inventor: Jan Hall, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 10/582,768

(22) PCT Filed: Dec. 6, 2004
(86) PCT No.: PCT/SE04/01804

§ 371 Date: Mar. 29, 2007

(30) Foreign Application Priority Data
Dec. 11, 2003 (SE) 0303324-8

(51) Int. Cl. A61C 8/00

(52) U.S. Cl. 433/174

(57) ABSTRACT

An implant (4) is intended to be fitted in a hole (5) formed in a jaw bone (1). The implant comprises an outer surface (9) which can interact with the soft tissue or connective tissue (2) of the jaw bone and which can be placed at the mouth (6) of the hole. The surface (9) is provided with one or more porous outer layers (10) intended to promote integration between the surface and the soft tissue (2) and to counteract penetration of organisms or bacteria that cause inflammation. By means of this arrangement, continued and substantial integration is maintained between the surface and the tissue. Previous production methods for the implant can be retained with only minor modifications.

The present invention relates to an implant intended to be fitted in a hole formed in a jaw bone. The implant comprises and/or is assigned an outer surface which can interact with the soft tissue or connective tissue of the jaw bone and which can be placed at the mouth of the hole.

Implants in dentistry are already well known. The implant is fitted in a hole formed as a threaded hole or as an unthreaded hole. In the latter case, the implant can be provided with its own thread or can be of what is called the self-tapping type. It is already known to provide the implant with a surface at its outer or upper parts to be located at the mouth of the hole when the implant is fitted. It is also already known to provide or arrange the implants with spacers (abutments) for securing the prosthesis that the implant is intended to support. Such spacers can be mounted on the implant or can be produced in one piece with the implant. It is also already known, for various purposes, to provide the surface of the implant with threads and recesses of different types, for example microthreads, and in this context reference may be made to, inter alia, U.S. Pat. No. 5,588,838 and U.S. Pat. No. 6,547,564 B1, WO 03/015654 A1, US 2003/0104338 A1, WO 01/49199 A2 and WO 01/50972 A2. Reference may also be made to the patent applications filed by the same Applicant and to the patents obtained concerning porous layers on implants, for example the porous layers available on the market under the tradename TiUnite®.

In this connection, two main problems have to be solved before an entirely satisfactory result can be achieved. The implant must, on the one hand, satisfy the requirement of excellent soft tissue integration between the surface and the soft tissue/connective tissue. On the other hand, the integration has to be lasting, so as to ensure that large areas of the contact surfaces and upper parts of the implant are not exposed after a certain length of time as a result of bone absorption, which is unacceptable for esthetic reasons, among others. The invention aims to solve this problem. It is also important that the means and measures taken to avoid the occurrence of said disadvantages do not complicate the structure of the implant and its use. The invention solves this problem too.

It should be noted that what is proposed by the invention goes against the prejudices existing in the dental field. Thus, for example, it has hitherto been proposed that the surface in question be subjected to precise machining and/or polishing in order to prevent attack by bacteria and organisms. This machining and/or polishing may in itself work against the integration result. Providing the surface in question with microthreads, for example, means that a point of entry may be created for bacterial attack and bacterial penetration into parts of the implant lying deeper in the jaw bone, giving rise to risks of said bone absorption.

The feature that can principally be regarded as characterizing an implant according to the invention is that the surface mentioned in the introduction is designed or coated with one or more porous outer layers intended, on the one hand, to promote integration between the surface and the soft tissue, and, on the other hand, to counteract accumulation of organisms or bacteria that cause inflammation, so as to ensure continued and substantial integration.

In further developments of the inventive concept, it is proposed to use layers having pores with diameters of ca. 1 μm (micrometer) or less. Thus, for example, pores with diameters of ca. 0.5 μm can be used. Said embodiments also entail that the porous layer on the surface will have a thickness of at most 5 μm, for example a thickness of ca. 3 μm. The layer of the first surface can also be related to a porosity which is optionally present on the rest of the implant. Thus, the porosity of the first surface can be reduced in relation to the porosity used in the rest of the implant and can be chosen, for example, in the range of 30-40% of the latter. In further illustrative embodiments, a larger area of the part of the implant supporting said surface is used. The first surface can be situated completely or partially on the implant and completely or partially on a part which can be applied to the implant and which can consist of an attachment component, spacer sleeve, etc. After the implant and its soft tissue part have integrated, integration between the first surface and the soft tissue or connective tissue should remain in order to avoid exposure of the underlying implant surface and permit the best possible esthetic result. In experiments, it has previously been shown that a height of the soft tissue above the bone margin should be 1.2-2.0 mm, preferably 1.5-1.8 mm. Further developments of the inventive concept are set out in the attached dependent claims.

By means of what has been proposed above, a novel approach to the structure and use of implants in dentistry is permitted. The invention goes against the prejudices in respect of the need for a high degree of surface smoothness and instead uses means in the form of a slight porosity in order to promote excellent integration between the surface and the soft tissue, even in the long term. In the case where the implant also has surfaces with a porosity to improve anchoring and, for example, provide a magazine for substances that stimulate bone growth, etc., at parts of the implant located below the surface, technical production can be made relatively simple by using different degrees of shot-peening and/or etching in different parts of the implant which are to have different degrees of coarseness of the porosity. The already known porosity used for bone-contact surfaces of implants marketed under the tradename TiUnite® can thus still be used, and these are designated here as a coarse porosity. To obtain the novel porosity specific to the actual surface, a porosity is used which is obtained in the same way as the known porosity and which is here called TiUnite® Soft, which has a degree of porosity as in the preferred embodiment of the coarse porosity. By controlling the voltage, current, time and electrolyte composition in the oxidation process, it is possible to control the porosity and structure of the surface so as to achieve optimum soft tissue integration. All or part of said surface can be coated with layers of the lower degree of porosity. The invention also functions in cases where the implants, apart from all or part of said surface, are without porosity.

A presently proposed embodiment of an implant according to the invention will be described below with reference to the attached drawings, in which:

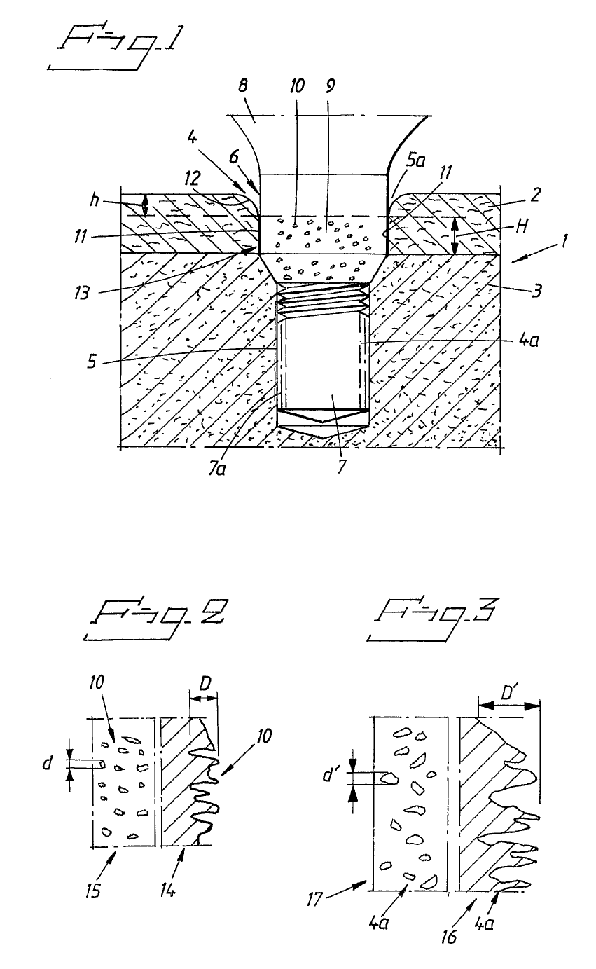

FIG. 1 shows a vertical cross section through an implant fitted in a hole in a jaw bone with soft tissue or connective tissue,

FIG. 2 shows, partially in vertical cross section and partially in horizontal view, a first porosity on a first surface of the implant according to FIG. 1,

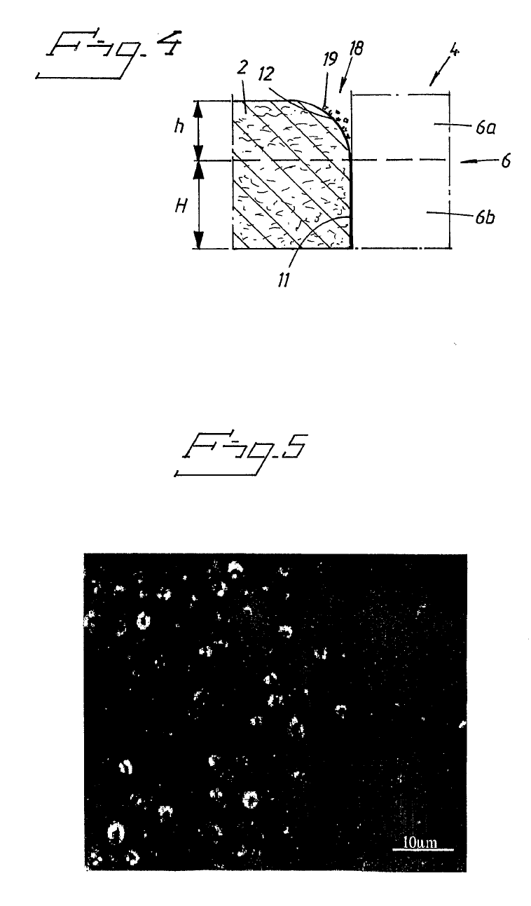

FIG. 3 shows a vertical cross section and a horizontal view of the porosity on one or more other surfaces of the implant,

FIG. 4 shows an enlarged view of parts of the implant according to FIG. 1,

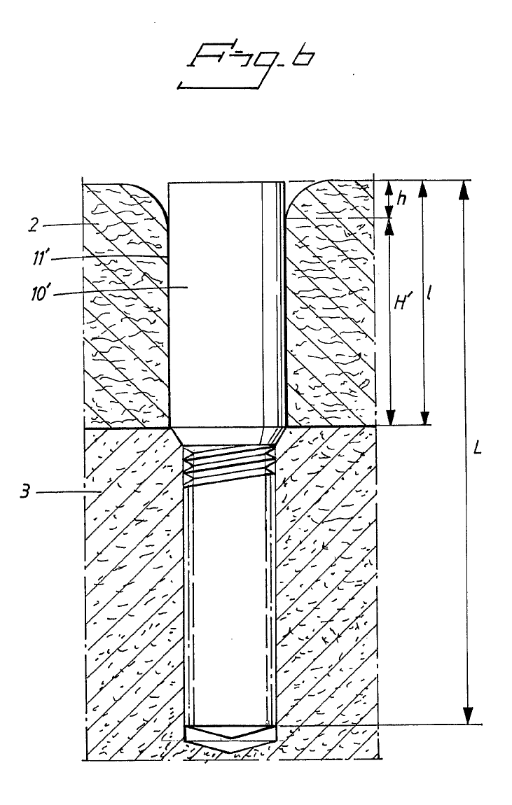

FIG. 5 shows a horizontal view of an example of the structure of the porosity of the first surface, at a magnification of 2000 times, and

FIG. 6 shows a vertical cross section through a second embodiment of the implant fitted in a hole in a jaw bone with soft tissue or connective tissue.

In FIG. 1, a section of a jaw bone is indicated overall by reference number 1. Above the actual jaw bone 3 itself, there is an area of soft tissue or connective tissue 2. An implant 4 is fitted in the jaw bone, specifically in a hole 5 that has been formed in said jaw bone. The implant is provided with upper parts 6 which are arranged at the mouth 5a of the hole. In the present case, the implant is provided with a surface or surfaces 7, and one or more threads 7a by means of which the implant can be screwed into the hole 5. Said upper parts 6 can form part of, or can themselves constitute, a means of securing a symbolically indicated prosthesis 8. Said upper parts 6 have a surface 9 which is completely or partially provided with a porosity 10, shown symbolically in the present case. If the surface 9 is provided partially with a porosity, the latter preferably extends across most of the surface. The porosity can in this case be arranged in bands or islands around and/or along the surface extending peripherally. In FIG. 1, a vertical extent for the interacting parts of the tissue 2 and the surface 9 is indicated by H. The interacting parts are indicated symbolically by 11. Said height H in the present case is 1.5-1.8 mm. By keeping the height H of the interacting surface 11, downward growth of epithelium is avoided and the upper parts 13 of the implant are not exposed. The implant 4 can be of the type which, in addition to the porosity 10 on the surface 9, can also comprise one or more other porosities 4a at parts lying below said surface 9. The other porosity can be arranged in a manner known per se and for a purpose known per se.

In FIG. 2, a vertical cross section through the porosity 10 is indicated by 14, and a horizontal section of the porosity 10 is indicated by 15. In accordance with the concept of the invention, the depth D of the porosity will be chosen with a value of 5 μm or less, for example 3 μm. The mean diameter d of the pores will be chosen at 1 μm or less, for example 0.5 μm.

In FIG. 3, reference number 16 indicates a vertical cross section through the porosity 4a, and reference number 17 indicates a horizontal section of the porosity 7. The porosity 4a is a coarser porosity compared to the porosity 10. In this connection, reference may be made to the TiUnite® implant sold on the market by the Applicant filing the present patent application. In the present case, the depth D′ can be 10 μm or more. The mean value of the diameter d′ in this case can be 2 μm or more.

FIG. 4 shows the structure of an embodiment of the implant 4 diagrammatically. The upper parts 6 of the implant can be regarded as comprising an upper part 6a and a lower part 6b. This implant structure may be used in a certain implantation technique in which one wishes to remove part of the implant during the actual fitting and period of incorporation. The part 6a can thus be fitted onto and detached from the part 6b. It can be applied and detached in a manner known per se, and this does not therefore have to be described in detail here. In accordance with the present invention, it is important that the part 6b remains in its position in which it is fitted from the outset and is not disturbed during the implantation and period of incorporation. According to the invention, therefore, the interacting surfaces 11 can remain unaffected throughout the implantation. This guarantees an initial high degree of integration between the soft tissue or connective tissue 2. The values of the height H or h can in this way be maintained, and said exposure is avoided. In FIG. 4, a small accumulation of bacteria and/or organisms is indicated symbolically by 18. It will be appreciated that said bacteria and/or organisms are easy to remove from the actual space 19 if the surface 6a is smooth and easy to clean. The interacting surfaces 11 constitute an effective barrier against penetration of bacteria and organisms to the underlying parts of the implant. The space in which accumulation possibly takes place is indicated by 19.

FIG. 5 shows an example of a porosity which has been produced by means of anodic oxidation and is intended to be arranged on the surface 9 according to FIG. 1. As regards the pore diameters and pore depths, reference is made to FIG. 2. The figure shows a magnification of 2000 times, and the distance of 10 μm is shown in FIG. 1.

In FIG. 6, reference number 10′ indicates a surface which is lengthened in relation to the surface 10 according to FIG. 1. In this case, the length of the implant is shown by L, and the length of the surface by l. The length of the surface 10′ coincides substantially in this case with the thickness of the soft tissue 2, but it can alternatively vary slightly from this. In the present case, the interacting surfaces 11 are lengthened, meaning that their height H′ considerably exceeds the height H in the illustrative embodiment according to FIG. 1. According to the illustrative embodiment, the length l of the surface is at least ⅓ of the total length L of the implant.

The invention is not limited to the embodiment shown by way of example above, and instead it can be modified within the scope of the attached patent claims and the inventive concept.

1. A dental implant for insertion into a hole formed in a jaw bone, the dental implant comprising:
a body that includes a first outer surface that is configured to interact with soft tissue (of the jaw bone and which can be placed at the mouth of the hole, wherein the first outer surface comprises a porous outer layer configured, to promote integration between the outer surface and the soft tissue and to counteract penetration of organisms or bacteria to ensure continued and substantial integration.

2. The dental implant as in claim 1, wherein the porous outer layer includes pores having mean diameters of less than or equal to about 1 μm.

3. The dental implant as in claim 1, wherein in that the porous outer layer has a thickness of less than or equal to 5 μm.

4. The dental implant as in claim 1, further comprising a second outer surface with a porosity that is coarser than the porosity of the first outer surface.

5. The dental implant as in claim 1, wherein the dental implant includes an upper implant part which comprises up to ⅓/the total length of the dental implant and the the first outer covers substantially all the upper implant part.

6. The dental implant as claim 1, wherein the first outer surface is at least partially situated on a part which can be applied to the implant.

7. The dental implant as in claim 1, wherein the dental implant is configured that the height of the soft tissue above the bone margin is between about is 1.2-2.0 mm, preferably 1.5-1.8 mm.

8. The dental implant as claim 1, wherein dental implant includes an upper/outer portion with inner and outer parts and wherein the inner part supports the first outer surface with the porous outer layer and the outer part can be temporarily removed during fitting of the dental implant.

9. The dental implant as in claim 1, wherein the porous outer layer is based on anodic oxidation.

10. The dental implant as in claim 1, wherein the porous layer is configured to allow only limited outer bone or tissue absorption at the mouth (5a) of the hole.

11. The dental implant as in claim 4, wherein the porosity of the outer surface is 30% to 40% of the porosity of the second outer surface.

12. The implant as in claim 6, wherein the first outer surface is at least partially situated on a part which is integrally formed with the rest of the implant.

13. The dental implant as in claim 7, wherein the dental implant is configured such that the height of the soft tissue above the bone margin is between about is 1.5-1.8 mm.
